(19) United States
(12) Patent Application Publication
(10) Pub. No.: US 2010/0225734 A1
(43) Pub. Date: Sep. 9, 2010

(54) STEREOSCOPIC THREE-DIMENSIONAL INTERACTIVE SYSTEM AND METHOD

(75) Inventors: Hayim Weller, Rechovot (IL); Tomer Yosef Morad, Tel Aviv (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/396,541

(22) Filed: Mar. 3, 2009

(51) Int. Cl. H04N 7/14; G09G 5/00; G06T 15/00

(52) U.S. Cl. 348/14.08; 345/156; 345/419; 348/E07.083

(57) ABSTRACT

The present invention relates to a method for providing a stereoscopic interactive object comprising the steps of: (a) providing a display capable of displaying in stereoscope; (b) providing a system capable of motion tracking; (c) providing a stereoscopic image of an object, on said display; (d) tracking user's motion aimed at interacting with said displayed stereoscopic image; (e) analyzing said user's interactive motion; and (f) performing in accordance with said user's interactive motion.

### FIELD OF THE INVENTION

The present invention relates to the field of stereoscopic 3-Dimensional displays. More particularly, the invention relates to a system and method for providing images of 3-D objects to users and allowing them to interact with the objects and interact with the system by gestures aimed at the images of the 3-D objects.

### BACKGROUND OF THE INVENTION

Stereoscopic display systems have developed enormously in recent years due to advances in processing power, and advances in 3-D display methods. As of today not only movies and pictures may be displayed in stereoscope but also games and multimedia contents are provided for stereoscopic displays.

Stereoscopic displays can be produced through a variety of different methods, where some of the common methods include:

Anaglyph—in an anaglyph, the two images are either superimposed in an additive light setting through two filters, one red and one cyan. In a subtractive light setting, the two images are printed in the same complementary colors on white paper. Glasses with colored filters in either eye separate the appropriate images by canceling the filter color out and rendering the complementary color black.

ColorCode 3-D—designed as an alternative to the usual red and cyan filter system of anaglyph. ColorCode uses the complementary colors of yellow and dark blue on-screen, and the colors of the glasses' lenses are amber and dark blue.

Eclipse method—with the eclipse method, a mechanical shutter blocks light from each appropriate eye when the converse eye's image is projected on the screen. The projector alternates between left and right images, and opens and closes the shutters in the glasses or viewer in synchronization with the images on the screen.

A variation on the eclipse method is used in LCD shutter glasses. Glasses containing liquid crystal will let light through in synchronization with the images on the display, using the concept of alternate-frame sequencing.

Linear polarization—in order to present a stereoscopic motion picture, two images are projected superimposed onto the same screen through orthogonal polarizing filters. A metallic screen surface is required to preserve the polarization. The viewer wears low-cost eyeglasses which also contain a pair of orthogonal polarizing filters. As each filter only passes light which is similarly polarized and blocks the orthogonally polarized light, each eye only sees one of the images, and the effect is achieved. Linearly polarized glasses require the viewer to keep his head level, as tilting of the viewing filters will cause the images of the left and right channels to blend. This is generally not a problem as viewers learn very quickly not to tilt their heads.

Circular polarization—two images are projected superimposed onto the same screen through circular polarizing filters of opposite handedness. The viewer wears low-cost eyeglasses which contain a pair of analyzing filters (circular polarizers mounted in reverse) of opposite handedness. Light that is left-circularly polarized is extinguished by the right-handed analyzer; while right-circularly polarized light is extinguished by the left-handed analyzer. The result is similar to that of stereoscopic viewing using linearly polarized glasses; except the viewer can tilt his head and still maintain left to right separation.

RealD and masterimage—are electronically driven circular polarizers that alternate between left and right-handedness, and do so in sync with the left or right image being displayed by the digital cinema projector.

Dolby 3-D—In this technique, the red, green and blue primary colors used to construct the image in the digital cinema projector are each split into two slightly different shades. One set of primaries is then used to construct the left eye image, and one for the right. Very advanced wavelength filters are used in the glasses to ensure that each eye only sees the appropriate image. As each eye sees a full set of red, green and blue primary colors, the stereoscopic image is recreated authentically with full and accurate colors using a regular white cinema screen.

Autostereoscopy is a method of displaying 3-D images that can be viewed without the use of special headgear or glasses on the part of the user. These methods produce depth perception in the viewer even though the image is produced by a flat device.

Several technologies exist for autostereoscopic 3-D displays. Currently most of such flat-panel solutions are using lenticular lenses or parallax barrier. If the viewer positions his head in certain viewing positions, he will perceive a different image with each eye, giving a stereo image.

Lenticular or barrier screens—in this method, glasses are not necessary to view the stereoscopic image. Both images are projected onto a high-gain, corrugated screen which reflects light at acute angles. In order to see the stereoscopic image, the viewer must sit perpendicular to the screen. These displays can have multiple viewing zones allowing multiple users to view the image at the same time.

Other displays use eye tracking systems to automatically adjust the two displayed images to follow the viewer's eyes as they move their head.

WO 2008/132724 discloses a method and apparatus for an interactive human computer interface using a self-contained single housing autostereoscopic display configured to render 3-D virtual objects into fixed viewing zones. The disclosed system contains an eye location tracking system for continuously determining both a viewer perceived 3-D space in relation to the zones and a 3-D mapping of the rendered virtual objects in the perceived space in accordance with a viewer eyes position. One or more 3-D cameras determine anatomy location and configuration of the viewer in real time in relation to said display. An interactive application that defines interactive rules and displayed content to the viewer is also disclosed. The disclosed interaction processing engine receives information from the eye location tracking system, the anatomy location and configuration system, and the interactive application to determine interaction data of the viewer anatomy with the rendered virtual objects from the autostereoscopic display. Nevertheless the disclosed tracking system requires a sophisticated tracking system for tracking the viewer's eyes in relation to the zones.

It is an object of the present invention to provide a method for displaying stereoscopic images of 3-D interactive objects.

It is another object of the present invention to provide a method for intuitively controlling a 3-D display system.

It is another object of the present invention to provide the user an interactive experience with a 3-D display and control system.

It is still another object of the present invention to provide a method for integrating stereoscopic display systems and movement tracking systems for providing an engulfing 3-D experience.

It is still another object of the present invention to provide a method for communicating 3-D experiences to a plurality of users located in different places.

Other objects and advantages of the invention will become apparent as the description proceeds.

### SUMMARY OF THE INVENTION

The present invention relates to a method for providing a stereoscopic interactive object comprising the steps of: (a) providing a display capable of displaying in stereoscope; (b) providing a system capable of motion tracking; (c) providing a stereoscopic image of an object, on said display; (d) tracking user's motion aimed at interacting with said displayed stereoscopic image; (e) analyzing said user's interactive motion; and (f) performing in accordance with said user's interactive motion.

Preferably, the method further comprises the step of adjusting the displayed stereoscopic image in accordance with the user's interactive motion.

In one embodiment the stereoscopic image of the object is super imposed over a stereoscopic movie.

In another embodiment the stereoscopic image of the object is super imposed over a 2-D movie.

In one embodiment the stereoscopic image is a web browser image.

The present invention also relates to a system for providing an intuitive stereoscopic interactive object comprising: (a) a display capable of displaying stereoscopic images; (b) a camera capable of capturing motion on a video stream; and (c) a control box capable of receiving and analyzing said motion on said video stream from said camera and capable of displaying a stereoscopic image of an object on said display and capable of controlling said system based on said motion.

Preferably, the control box is capable of interpreting a 3-D image from a video stream showing an object from all sides.

Preferably, the system adjusts the displayed stereoscopic image of the object in accordance with the user's interactive motion.

In one embodiment, the system is used for video conferencing.

In one embodiment, the video conferencing is between two or more participants.

In one embodiment, the system is used for sharing stereoscopic 3-D images.

In one embodiment, the system is used for integrating data from more than two participants.

### BRIEF DESCRIPTION OF THE DRAWINGS

In the drawings:

FIG. 1 is a schematic diagram of a 3-Dimensional interactive control system according to one embodiment of the invention.

FIG. 2 is a schematic diagram of a 3-Dimensional video conferencing system according to one embodiment of the invention.

### DETAILED DESCRIPTION OF PREFERRED EMBODIMENTS

The following description of the method of the invention may be used with any method or system for stereoscopic displaying, such as the Anaglyph method, the Eclipse method, the barrier screens method, or any other known 3-D imaging display method. The following description also uses video motion tracking which is the process of locating a moving object in time using a camera. An algorithm analyzes the video frames and outputs the location and motion of moving targets within the video frames. The video tracking systems typically employ a motion model which describes how the image of the target might change for different possible motions of the object to track. For the purpose of the invention any known video tracking method may be used such as: Blob tracking, Kernel-based tracking (Mean-shift tracking), Contour tracking, etc.

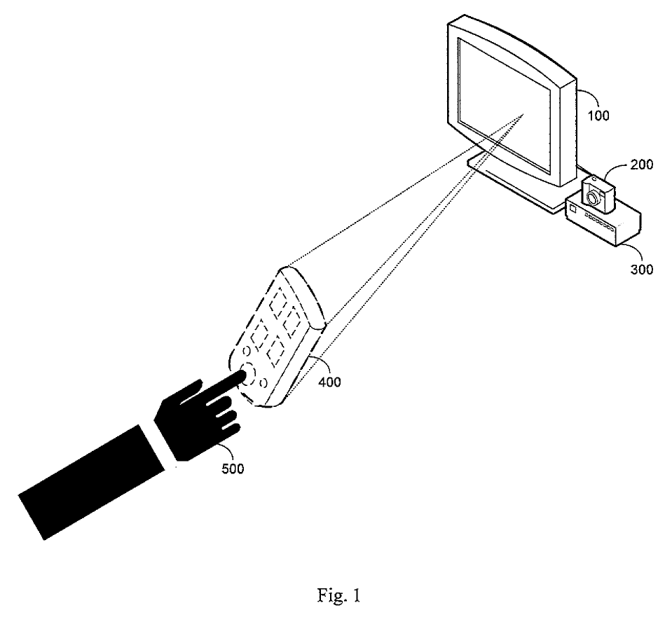

FIG. 1 is a schematic diagram of a 3-Dimensional interactive control system according to one embodiment of the invention. In this embodiment the user may be watching a movie or any other media contents on screen 100. Camera 200 which may be a simple web camera, a 3-D camera, or a number of cameras located at different angles to capture in 3-D the motion of the user. When the user is watching the movie on screen 100 he may wish to control the system, e.g. to turn the volume up. At this point the user may signal to the system to display a remote control in any conceivable way such as: waving, raising a hand, clapping, turning a virtual knob, or any other preset gesture or signal. The control box 300, which is capable of analyzing motion from a video stream, i.e. video motion tracking, receives the video stream from camera 200 and identifies the gesture. The control box 300 may be a Set-top box (STB), a computer, or any other processing element capable of processing incoming video data from camera 200 and capable of producing a media stream for displaying stereoscopic objects. After identifying the gesture and its approximated location, control box 300 displays an image of a remote control 400 (in silhouette) in stereoscope on screen 100 in the approximated location of the users hand or any other preset location. Once the user sees the image of the remote control 400 in stereoscopy he can try to manipulate the image by pressing, with his hand 500, a button, or turning a knob of the displayed remote control 400 or any other motion aimed at controlling the system. At this point the attempted manipulation, i.e. the hand motion, is filmed by camera 200 and sent to control box 300 which analyzes the incoming video stream, tracks the motion, and proceeds accordingly. If the user tries to turn the knob of the volume, on remote control 400, the control box 300 can change the volume of the movie accordingly and change the image display of the volume knob of remote control 400 accordingly, as if it had been turned. Thus the user may receive the experience as if he is turning a knob of a real remote control. In one embodiment, the displayed remote control 400 may be super imposed over the displayed movie. Thus the user may continue watching the movie while using the remote control without the need to lower his eyes from the screen and look for the remote control.

In one of the embodiments, control box 300, as described in relation to FIG. 1, is integrated in screen 100. In another embodiment the camera 200 is integrated in control box 300. In yet another embodiment camera 200 and control box 300 are integrated together in screen 100, or any other combination thereof.

In one of the embodiments, the stereoscopic interactive 3-D remote control image is super imposed over a stereoscopic video. In another embodiment the stereoscopic 3-D interactive remote control image is super imposed over a 2-D video. In yet another embodiment, the stereoscopic 3-D interactive remote control image is displayed alone without being super imposed over a video. The stereoscopic interactive remote control image may be super imposed over a video, a single picture, or any other multimedia or graphical display.

In one of the embodiments, the stereoscopic view is a view of an internet browser where the user may control the browser using gestures of his hands aimed at the browser or aimed at a stereoscopic displayed control.

In one of the embodiments the system of the invention is used to display a number of stereoscopic images of 3-D objects. In this embodiment the STB 300, as described in relation to FIG. 1, may receive a video stream containing a 2-D movie together with 3-D data on certain objects within the 2-D movie. For example, in a certain movie a number of objects, of the movie, may be shown in 3-D stereoscope and the user may manipulate, control or erase these objects. The manipulation may include turning, pressing, pulling, or any other gesture aimed at these objects. In one of the embodiments the system of the invention is used to display stereoscopic 3-D images of objects for commercial purposes. For example, the user may be shown merchandise where he can turn and see the merchandise from all sides. In another example the user may be shown an inside of a car where he can manipulate the steering wheel or gear of the car, where a turn of the steering wheel can affect the displayed scenery and a gear change can affect the sound, or any other desired effects.

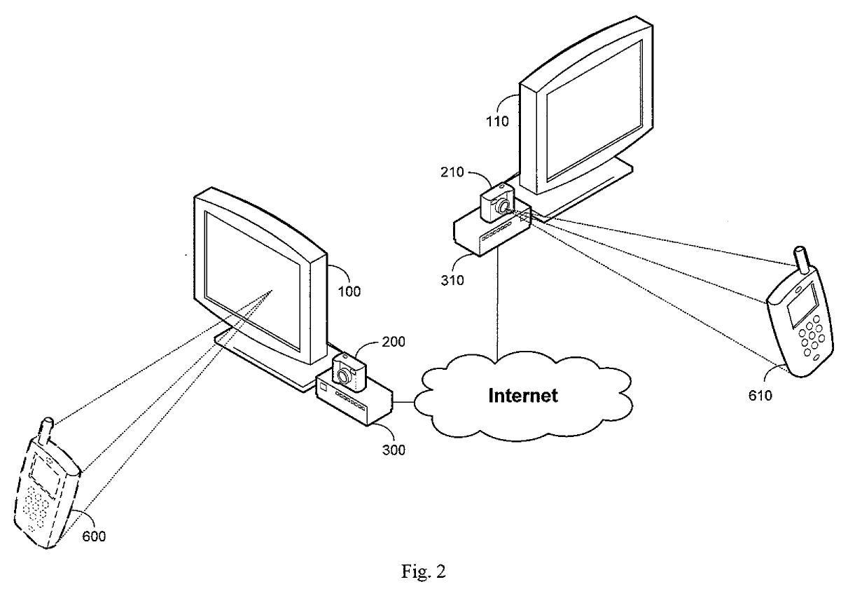

FIG. 2 is a schematic diagram of a 3-D video conferencing system according to one embodiment of the invention. In this embodiment a presenter wishes to show a 3-D presentation of the cellular phone 610 to a participant he sees on screen 110. The user first shows cellular 610 to his system's camera 210, which films the phone 610, from all sides. Camera 210 may be a simple web camera, a 3-D camera, or a number of cameras located at different angles. In order to film the phone 610 from all sides the presenter may twist and turn the phone 610 from all sides in front of camera 210. The video stream of the filmed phone 610 is sent from camera 210 to control box 310 which analyzes the video stream and processes the video stream into a 3-D presentation. The 3-D presentation is then sent through the internet or any other communication medium to the participant's control box 300, as described in relations to FIG. 1. The control box 300 can then display a stereoscopic 3-D image 600 of the cellular phone, on screen 100, according to the 3-D presentation data it received from the presenter's control box 310. The participant can try to press the phone image 600 buttons, which the camera 200 can film and send the video stream of the pressing motion to control box 300. Control box 300 may then analyze the pressing motion and proceed according to the information it received about the phone or the motion may be sent to the presenter's control box 310 for a response. The presenter may interact with a number of participants where each participant receives the 3-D interactive image from the presenter. The information of a 3-D interactive image may also be stored on a server.

In one embodiment, the participants may also interact with one another. In another embodiment, the participants may each show, film, and display their own 3-D image to the other participants.

In one of the embodiments the system is used for distance learning. A teacher or any person can display and show in stereoscope the 3-D object he wishes to teach about. For example a music teacher can show a student a 3-D image of the music instrument he is talking about.

In one of the embodiments each participant may be shown a stereoscope 3-D interactive image where his motions and interactions may be integrated with the interactions of other participants. For example, a band may play together where each player of the band sits at his house and interacts with an image of an instrument. When the drum player interacts with an image of a 3-D drum, the system may analyze and interpret his beating motions to the sound expected from the displayed drum. The sound of the drum may then be integrated with the sound interpreted from the organ player and the other players and played to all the participants.

In one of the embodiments, the system displays stereoscopic images of 3-D objects, such as pictures, music albums, video cassettes, etc., where the user can point or signal with his hands to which object he wishes to control. For example, the user may be shown titles of songs where he can point and pick the order of the songs he wishes to hear. In another example the user is shown a progressive slider of a movie, and the user can signal with his hand for the system to jump to a certain scene or chapter within the movie. In yet another example the user is shown a book where he can thumb through the book pick a certain paragraph, signal to copy and save a paragraph, and close the book.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for providing a stereoscopic interactive object comprising the steps of:
a. providing a display capable of displaying in stereoscope;
b. providing a system capable of motion tracking;
c. providing a stereoscopic image of an object, on said display;
d. tracking user's motion aimed at interacting with said displayed stereoscopic image;
e. analyzing said user's interactive motion; and
f. performing in accordance with said user's interactive motion.

2. A method according to claim 1, further comprising the step of adjusting the displayed stereoscopic image in accordance with the user's interactive motion.

3. A method according to claim 1, where the stereoscopic image of the object is super imposed over a stereoscopic movie.

4. A method according to claim 1, where the stereoscopic image of the object is super imposed over a 2-D movie.

5. A method according to claim 1, where the stereoscopic image is a web browser image.

6. A system for providing an intuitive stereoscopic interactive object comprising:
a. a display capable of displaying stereoscopic images;
b. a camera capable of capturing motion on a video stream; and
c. a control box capable of receiving and analyzing said motion on said video stream from said camera and capable of displaying a stereoscopic image of an object on said display and capable of controlling said system based on said motion.

7. A system according to claim 6, where the control box is capable of interpreting a 3-D image from a video stream showing an object from all sides.

8. A system according to claim 6, where the system adjusts the displayed stereoscopic image of the object in accordance with the user's interactive motion.

9. A system according to claim 6, where the system is used for video conferencing.

10. A system according to claim 9, where the video conferencing is between two or more participants.

11. A system according to claim 10, where the system is used for sharing stereoscopic 3-D images.

12. A system according to claim 10, where the system is used for integrating data from more than two participants.
